(19) United States
(12) Patent Application Publication
(10) Pub. No.: US 2015/0382151 A1
(43) Pub. Date: Dec. 31, 2015

(54) Computerized Coordination Of Social Service Resources

(71) Applicant: Carol L Pariani, St. Louis, MO (US)

(72) Inventor: Carol L Pariani, St. Louis, MO (US)

(21) Appl. No.: 14/739,141

(22) Filed: Jun. 15, 2015

Related U.S. Application Data
(60) Provisional application No. 62/017,051, filed on Jun. 25, 2014.

(51) Int. Cl. H04W 4/04; G01S 19/01

(52) U.S. Cl. CPC H04W 4/04; G01S 19/01; H04W 84/042

(57) ABSTRACT

The present disclosure relates to systems, devices and methods for computerized coordination of social services resources. According to one aspect, a mobile computing device for accessing basic need resources generally includes a processor, memory, a display, a global positioning satellite receiver, and a wireless communication element. The processor is configured to determine a location of the computing device based on a global positioning satellite signal, communicate with one or more wireless networks to determine one or more basic need resources located near the location of the computing device, and display resource information on the display for each of the one or more basic need resources. The resource information includes, for each of said one or more basic need resources, both a location of said basic need resource and instructions for the user on how to access said basic need resource.

### CROSS-REFERENCE TO RELATED APPLICATION

This application claims the benefit of U.S. Provisional Application No. 62/017,051, filed Jun. 25, 2014. The entire disclosure of the above application is incorporated herein by reference.

### FIELD

The present disclosure generally relates to systems, devices and methods for computerized coordination of social services resources.

### BACKGROUND

This section provides background information related to the present disclosure which is not necessarily prior art.

Resources and services for meeting basic needs may be provided between government, university and colleges, nongovernment organizations (NGOs), communities, and families and individuals. Basic needs may include shelter, utilities, food, clothing, childcare, healthcare, transportation, education, employment, etc. Populations in transition may need assistance in meeting basic needs. Populations in transition may include seniors, laid-off workers (e.g., middle-aged laid-off workers, etc.), women who are heads of households, young adults with an associate degree or some college education, veterans, offenders, people experiencing disability, etc.

### SUMMARY

This section provides a general summary of the disclosure, and is not a comprehensive disclosure of its full scope or all of its features.

According to one aspect of the present disclosure, a mobile computing device for accessing basic need resources generally includes a processor, memory configured to store information, a display configured to display information to a user, a global positioning satellite receiver configured to receive a global positioning satellite signal to determine a location of the computing device, and a wireless communication element configured for wireless communication via one or more wireless networks. The processor is configured to execute computer-executable instructions to cause the processor to determine a location of the computing device based on the global positioning satellite signal received by the global positioning satellite receiver, communicate with one or more wireless networks via the wireless communication element to determine one or more basic need resources located near the location of the computing device, and display resource information on the display for each of the one or more basic need resources. The resource information includes, for each of said one or more basic need resources, both a location of said basic need resource and instructions for the user on how to access said basic need resource.

According to another aspect of the present disclosure, a mobile computing system for accessing basic need resources generally includes a processor, memory configured to store information, a display configured to display information to a user, a global positioning satellite receiver configured to receive a global positioning satellite signal to determine a location of the mobile computing system, and a wireless communication element configured for wireless communication via one or more wireless networks. The processor is configured to execute computer-executable instructions to cause the processor to display a budget on the display having one or more budget categories, receive budget input information from the user corresponding to each of the one or more budget categories, determine whether a budget deficit exists for each of the one or more budget categories. The processor is also configured to, for each budget category having a budget deficit, determine one or more basic need resources corresponding to the budget category and located near the location of the computing device, and display a linking button adjacent said budget category having the budget deficit. The linking button is configured to link the user to said one or more basic need resources corresponding to said budget category having the budget deficit.

According to yet another aspect of the present disclosure, a method of accessing basic need resources via a mobile computing device is disclosed. The mobile computing device generally includes a processor, memory, a display, a global positioning satellite receiver, and a wireless communication element. The method generally includes determining a location of the computing device based on a global positioning satellite signal received by the global positioning satellite receiver, communicating with one or more wireless networks via the wireless communication element to determine one or more basic need resources located near the location of the computing device, and displaying resource information on the display for each of the one or more basic need resources. The resource information includes, for each of said one or more basic need resources, both a location of said basic need resource and instructions for the user on how to access said basic need resource.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a block diagram illustrating high level integration of an example system for accessing basic need resources.

FIG. 2 is a flowchart summarizing the process from the customer perspective for another example system for accessing basic need resources.

FIG. 3 is a flowchart summarizing the process from the interface perspective for another example system for accessing basic need resources.

FIG. 4 is a screen shot of an example display, designed for meeting financial and goal-oriented need.

FIG. 5 is a screen shot of another example display for resources and services, and mechanisms for interaction and feedback.

FIG. 6 is a screen shot of example direct links to resources and services fulfilling basic needs of shelter, utilities, food, clothing, childcare, healthcare, transportation, education, and employment.

FIG. 7 is a summary diagram of another example system for accessing basic need resources illustrating a capability to budget, access resources and services, and obtain feedback.

FIG. 8 is a block diagram of another example system for accessing basic need resources.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Some aspects of the present disclosure include an application called My Home (MH) and an application called My Community (MC). These example applications are tools that can be used, in whole or part, in coordination of resources and services between government, university and colleges, nongovernment organizations (NGOs), communities, and families and individuals (e.g., the stakeholders), creating a network of collaboration for meeting basic needs. Basic needs may include shelter, utilities, food, clothing, childcare, healthcare, transportation, education, employment, etc. A focus of controlled tailored modules described herein is to assist populations in transition (e.g., the “unutilized and underutilized”, working poor, etc.) as they fluctuate in and out of employment or assistance. Those in transition may include seniors, middle-aged laid-off workers, women who are heads of households, young adults with an associate degree or some college education, veterans, offenders, people experiencing disability, etc. The example My Home (MH) and My Community (MC) applications may provide means to improve conditions that lead to the recovery of individuals and families, by providing a central navigable tool.

Embodiments described herein may provide dynamic technological tools, may be created using a family perspective, and may match a specific basic need to the resources and services required to fulfill that need. The need can be a financial one, goal-oriented, etc. The customer (e.g., client, household, etc.) may be guided using buttons linked from a budget (e.g., inflows, outflows, etc.) directly to resources and services for ease of accessibility. The controlled tailored modules described herein may allow the customer to interact and provide feedback, which may create database opportunities for research and social policy development, and may require system production and maintenance, disclaimers and risk management. Example embodiments may be used in whole or part across a number of platforms, including computer websites, kiosks, mobile devices (e.g., laptops, cell phones, tablet computers, personal digital assistants, portable media players, APPLE IPAD, APPLE IPHONE, APPLE IPOD TOUCH, global positioning satellite (GPS) receivers, etc.). Like other forms of communications, devices can be programmed to include bilingual capabilities.

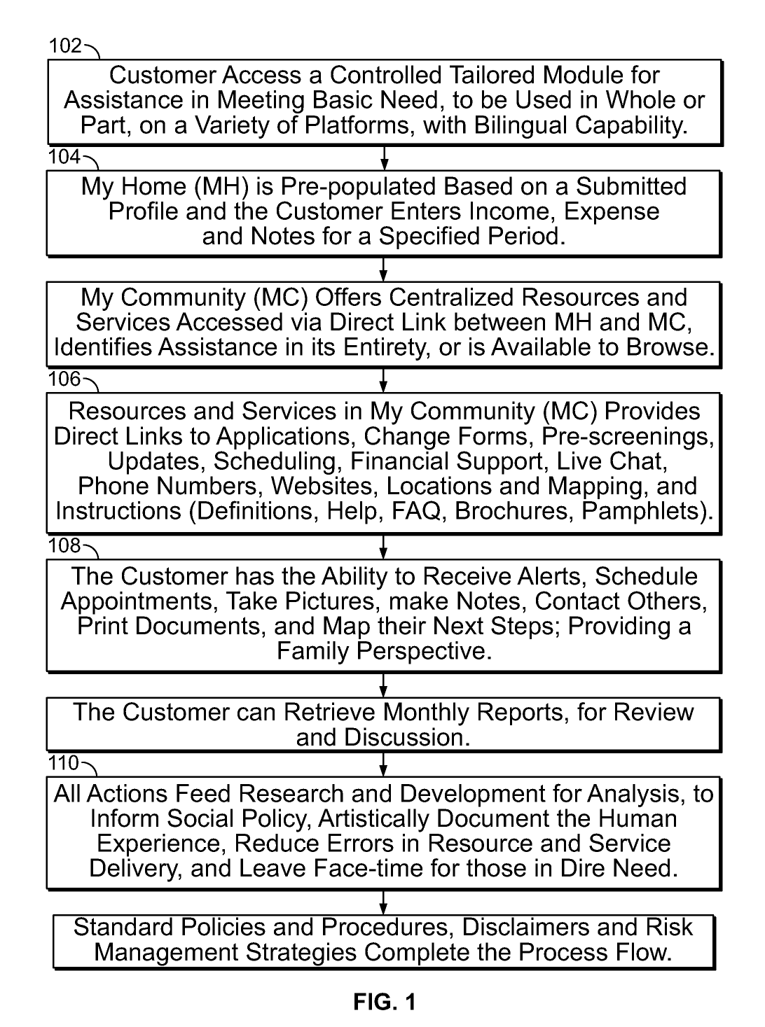

As depicted in FIG. 1 at 102, the example My Home (MH) and My Community (MC) applications may be controlled tailored modules for specific populations in transition. They can be used in whole or part across a number of platforms, and may include bilingual capability.

At 104, the example My Home (MH) application may be programmed to maintain a customer profile for ease of budgeting. The profile may include financial assistance, may display utility expense from month to month, may add documentation of the overall experience, etc. Information may be retained for a specified period.

The example My Home (MH) application may include an itemized budget. The example My Community application may include multiple icons corresponding to different basic need resource categories. The itemized budget and each individual My Community MC icon may link directly to resources and services as defined by corresponding needs. The My Community (MC) environment may identify all assistance available for viewing, and may also be browsed.

At 106, the direct links may provide the customer with applications, change forms, pre-screenings and a feed for information collected by paper, phone or in-office. The links may allow for the ability to check status or review applications, provide the capability to pre-date scheduled lay-offs due to seasonality or contract work-flow, may assist with finding financial support, may have live chat capability, one or more phone numbers, one or more websites, one or more locations for other specific resources and services, mapping, a drop down list for selection and instructions (e.g., definitions, help, frequently asked questions (FAQ), pamphlets, brochures, etc.) etc. Information may be retained and sorted based on a customer's past interaction with the module.

As shown in FIG. 1 at 108, the example modules may allow the user to receive alerts, schedule appointments, take pictures, make notes, contact others for assistance, print documents, map their next steps/actions, etc. All actions may be tied back to a particular resource or service, which may provide a family perspective. The user may also have the ability to retrieve and print past budget reports for review and discussion.

At 110, resources and services may interface with actions taken by the user for specialized analysis. A feed of statistics and data can be sent to stakeholders engaged in research and development, which may allow for longitudinal studies. The user's pictures and notes may help to understand and artistically document the human experience. Generated reports can be taken into consideration with development of programs and social policies. A tailored module format may provide controlled outcomes and reduce misinformation. As a result of incorporating the module into daily lives of populations in transition, face-time may be used for those who are in dire need.

The example My Home (MH) and My Community (MC) applications are unique because they may allow for direct links, in a controlled tailored environment, for access to basic need centralizing resources and services. Standard policies and procedures may enhance the technological design. Disclaimers and risk management strategies may be important to this type of innovation. This technological tool may be a long-term project whose use has the potential to grow exponentially.

Access to a controlled module may be single-layer or multi-layer, depending on the security decision. For example, an access sequence may first include a logo, then My Home (MH) or My Community (MC) (e.g., single-layer); or an access sequence may include Logo, then My Home (MH), then My Community (MC) (e.g., multi-layer). The module may require unique customer identification, process-flow, may allow for profile data entry, etc. A unique customer identifier can be retrieved through various methods if lost. A license agreement could also be obtained.

If profile data is sought, a user may create an account. The module may collect, update, populate, store, etc. customer profile data. Prompts may include “create a profile”, “update the profile” and press (e.g., click, etc.) “MH” to populate profile data in My Home (MH). This may eliminate the redundancy of entering reoccurring periodic data such as financial assistance or utility expense.

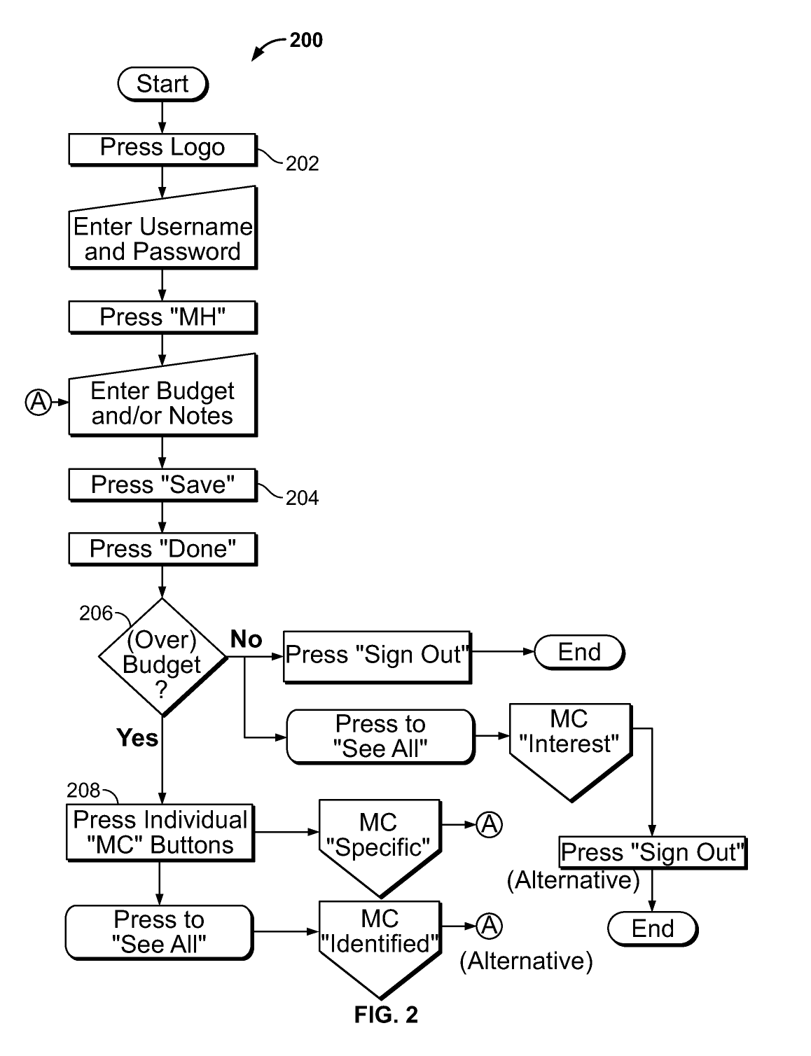

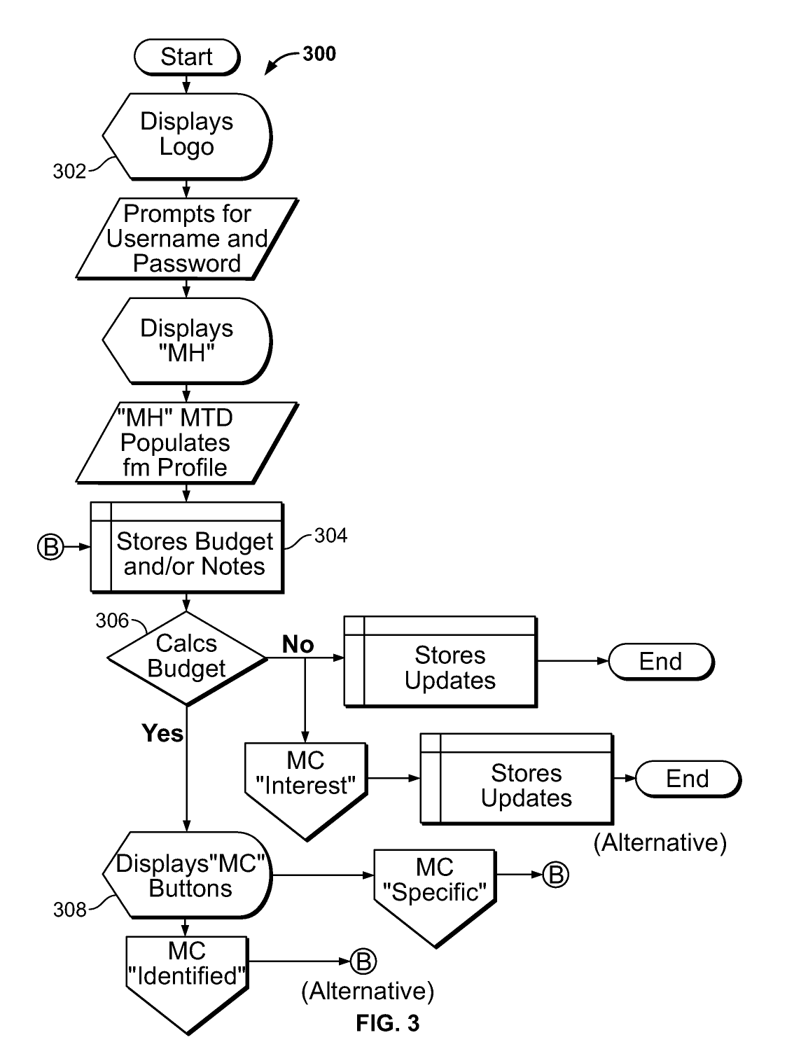

FIG. 2 and FIG. 3 illustrate an example of a multi-layer secured entry with profile data. FIG. 2 illustrates a flow diagram of an example process 200 from a user perspective showing what the user may see on the display while using the application. FIG. 3 illustrates a flow diagram of an example process 300 from an interface perspective showing what the example application is doing while the user is using the application.

Referring to FIG. 3, the module starts with a logo at 302 (corresponding actions are shown in FIG. 2, starting with 202). The user then presses the “Logo”. The module prompts for a Username (Forgot your username?) and Password (Forgot your password?) or some type of unique secured account entry. The user then enters the prompted information. The module displays “MH”. The user presses “MH”. The module then opens and populates My Home (MH) with the current month and year profile data. The user enters budget information (e.g., income, expense, etc.), notes, etc., at then presses “Save”. The module stores the budget information, notes, etc. at 304. This may not complete the work, but just keep the information entered from being lost. When finished, the user presses “Done”. Then, at 306, the module calculates any budget deficiencies and updates storage with any changes.

If the budget is over, a series of “MC” buttons may populate the screen, at 308. The user can press the individual “MC” buttons and the module directs the user to fulfillment of that specific need. Alternatively, or additionally, the user can press “See all” and the module brings up all available assistance identified by the module based on a predetermined tailored hierarchy. The user may toggles between My Home (MH) and My Community (MC), entering adjustments or notes, and may press “Save” to protect any changes, as the module stores updated information.

If the budget is under (or balanced), no further action between My Home (MH) and My Community (MC) may be necessary. Alternatively, or additionally, the user can still press “See all” and be taken to browse any resources and services.

Once all needs are met to the fullest extent possible (preferably balanced or under budget), the user “Signs out”. The module may store the month's report (budget, notes, etc.) in a file for user retrieval. The user may have available features including notes, pictures, scheduling, contacts, printing, mapping, etc. which can be engaged at any time throughout the process. The module documents and stores all actions for research and development.

It should be apparent that other example embodiments may include operations in other orders, include more or less (or different) operations than shown in FIGS. 2 and 3, etc.

Any suitable computing device may be used for the embodiments described herein. For example, cell phones (e.g., smartphones, etc.) are affordable technology, may have WiFi, cellular (e.g., 3G, 4G, LTE, etc.), etc. connectivity, may include an embedded GPS receiver, may have anti-theft features, may have virus protection, etc. Other computing devices may include laptops, tablets, personal data assistants (PDAs), etc.

The example modules described herein can be designed for restricted access, registration and privacy protection, may direct the user to terms and conditions, definitions, guidelines, help, FAQ, brochures, pamphlets, etc.

The example My Home (MH) and My Community (MC) applications are simple modules tailored to assist populations in transition. Those in transition may include seniors, middle-aged laid-off workers or other laid-off workders, women who are heads of households, young adults with an associate degree or some college education, veterans, offenders, people experiencing disability, etc. Each transitioning group may have a module designed to meet their specific need. This may be identified during the ongoing assessment of all stakeholders; government, university and colleges, nongovernment organizations (NGOs), communities, families, individuals, etc. The example modules have the potential for around the clock real-time access, and they may support appropriate use of technology.

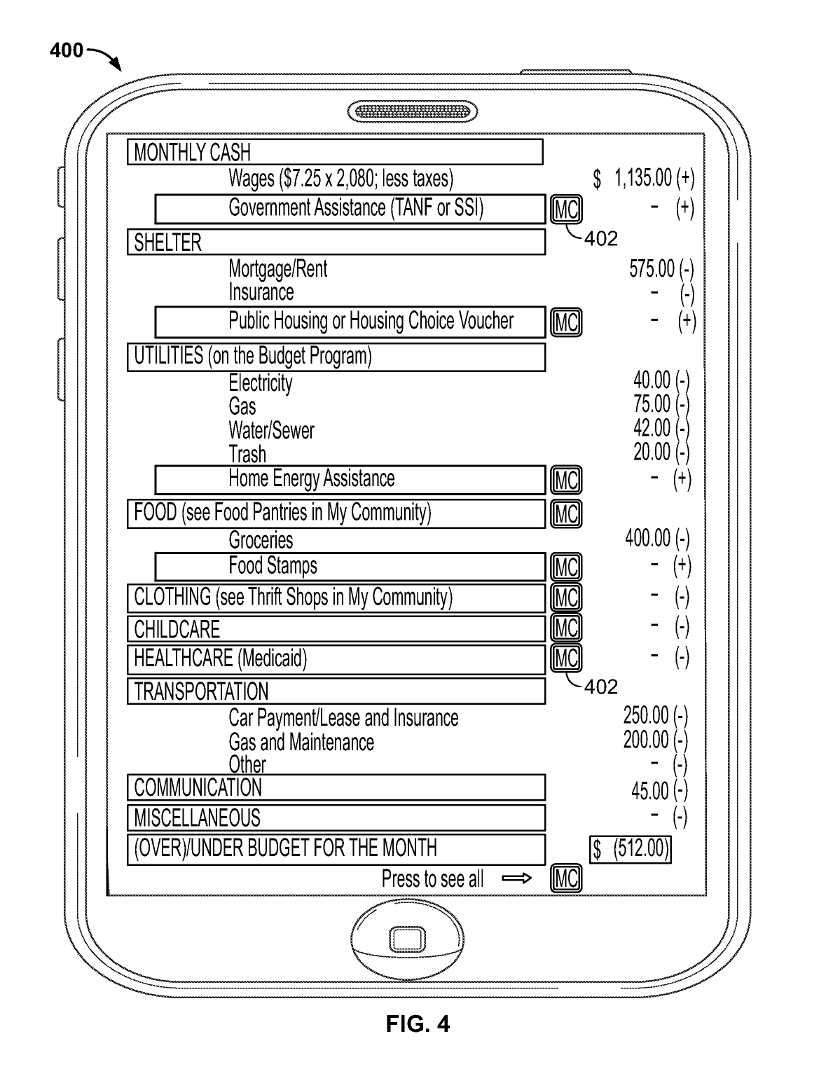

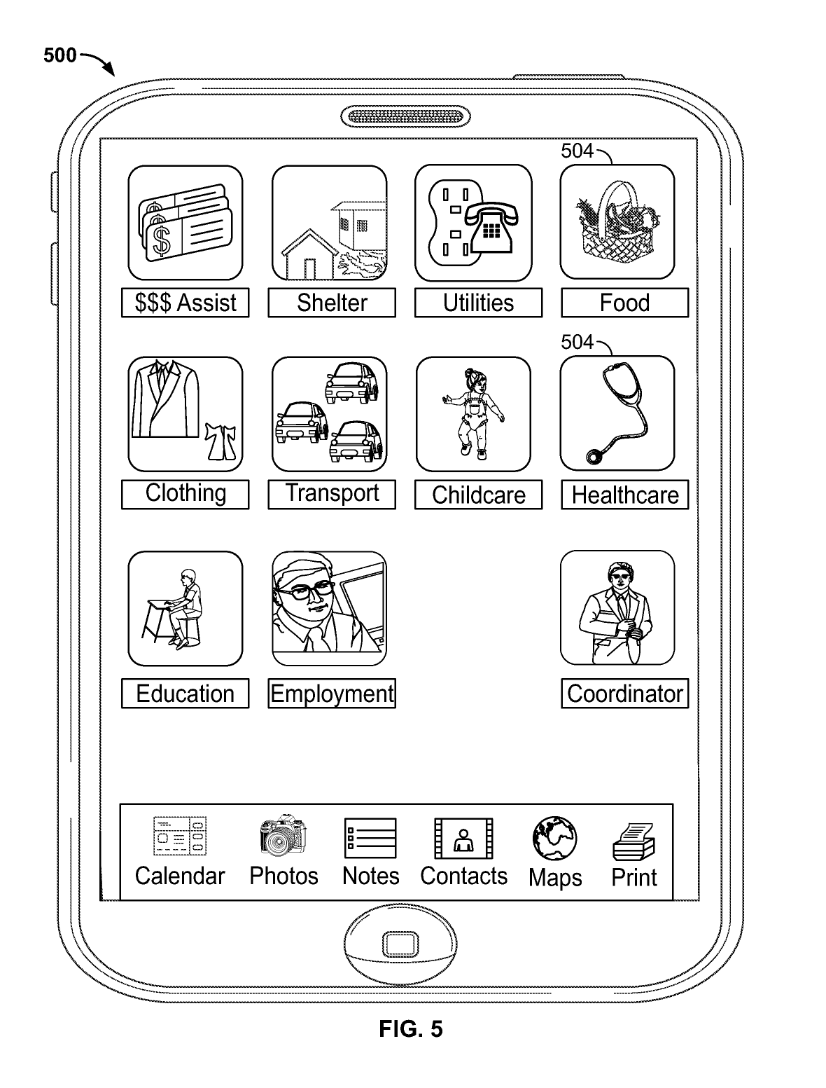

An example My Home application interface 400 is shown in FIG. 4. The interface 400 may connect the basic needs of My Home (MH) to the resources and services of the example My Community (MC) application as shown in the example My Community interface 500 of FIG. 5. These interfaces may introduce a main point of access, may use three instead of two interfacing layers, may allow for additional security features if necessary, etc. Basic information, along with username, password (or an answer to a security question), may be all that is needed to enter in whole or part. A drop down list may be included to select a language, which may eliminate barriers to resources and services based on a necessity for interpretation. For example, Spanish languages, Bosnian languages, etc. may be included.

The user may enter the applications through a specified access point and then press My Home (MH). The My Home (MH) interface 400 shown in FIG. 4 is an interactive tool that may assist the customer in navigating through basic needs. Basic needs may include shelter, utilities, food, clothing, childcare, healthcare, transportation, education, employment, etc. The user may input pay (or My Home (MH) may do this from a bank account, or My Home (MH) may hard codes pay, etc., based on the design of this tailored module). Wages can be seen as salaries paid, unemployment, social security, Veterans benefits, child support receipts, other sources of income, etc. Expenses may be entered in a similar fashion.

As the user's wages and expenses fluctuate other assistance may become available, for instance Temporary Assistance for Needy Families (TANF), Housing Assistance, Utilities, Food Stamps, etc. The user may press “Save” to save entries or “Done” to calculate budget deficiencies for the period specified. If the budget is under (or balanced), the user can still “Press to see all” to browse information in the My Community (MC) interface 500 shown in FIG. 5, or the user may be done. If the budget is over, a series of buttons 402 (e.g., linking buttons, direct links, etc.) may populate the screen to assist the user. The user can press the individual buttons 402 to go directly to that resource or service in the My Community (MC) interface 500 as shown in FIG. 5, or “Press to see all” to review all marked (e.g., highlighted, checked, hover capability, etc.) resources and services in the My Community (MC) interface 500.

The user may press “Done” to calculate budget status. If the budget is under (or balanced), the individual buttons may be gone, and the user's journey may be complete. The “Press to see all” button may still be available for access to resources and services in the My Community (MC) interface 500 shown in FIG. 5. If the budget is over, the user can press the remaining buttons to go directly to those resources or services or “Press to see all” to review all marked (e.g., highlighted, checked, hover capability, etc.) resources and services in My Community (MC). The user may also consider looking for odd jobs or work from home lists in the Community Job Posting icon. The month's budget, interactions and feedback are saved, can be printed, are stored, etc. and may be accessed by the user, a research and development team.

When the user is in need of additional support the module may provide a direct link to or interface with My Community (MC) as shown in FIG. 5 where other resources and services can be found. Various icons 504 can be interfaced to public or private access to funding. Certain icons 504 may be marked to guide in assistance of fulfilling other basic needs. An icon 504 may be devoted to Community Job Postings. There may be a queue for Community Coordinators such as Customer Service Representatives, Eligibility Specialists, Case Workers, etc. including a call line, live chat capability, etc.

The My Community (MC) interface 500 shown in FIG. 5 may make use of current technology. For example, the interface may include a calendar to schedule appointments, an alarm to track appointments, a camera and notes to document experiences, quick access to contact lists and maps, print capability, etc. An icon may be included for safety alerts via text, email, etc., which may target specific populations. Alerts, for example, may be needed to tell the user when a food pantry is out of food, when the Housing Authority is no longer accepting applications, may notify about changes in government policy, etc. Consideration may be given to visibility and functionality of the design.

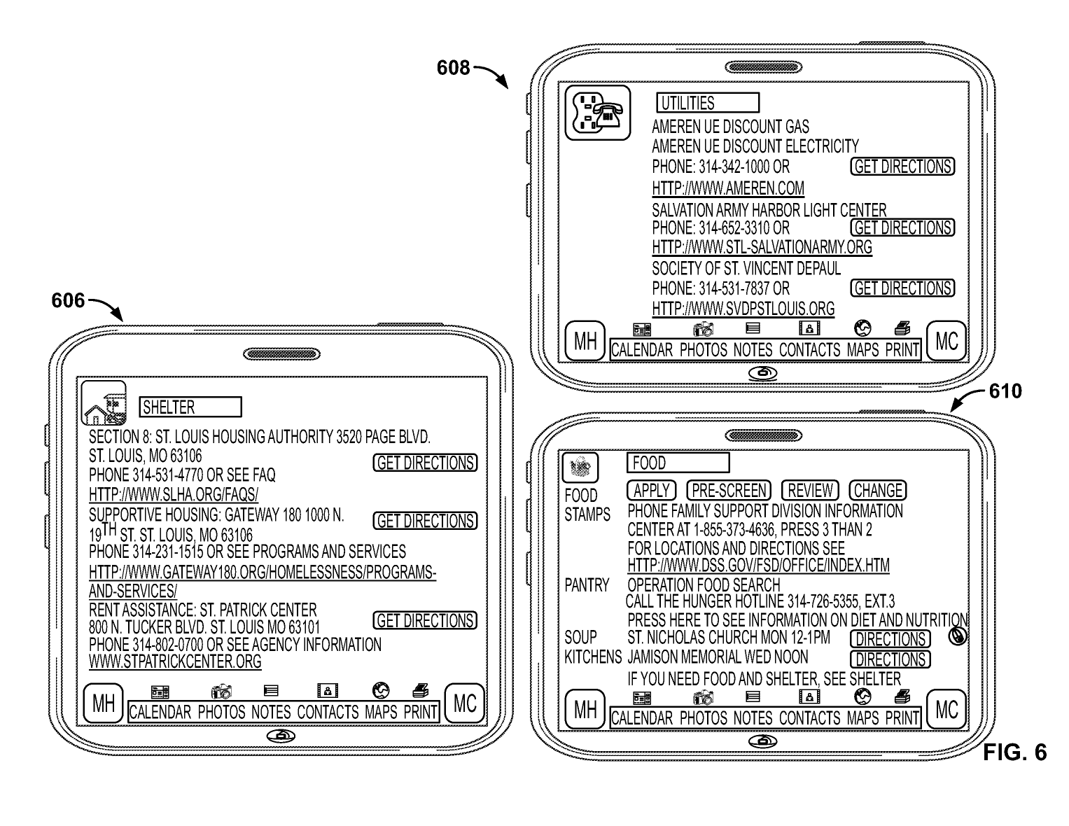

The user may review each resource and service independently. FIG. 6 illustrates an example of the screens that may be provided when a user presses, shelter (606), utilities (608) or food (610). The module feeds in information, allowing the customer to scroll up or down through choices. Each screen may contain an identifiable marker, may pull in appropriate information, may allow for feedback, may have navigational tools, etc. Shelter (606) is one of the most critical basic needs, and so the My Community (MC) pages may reflect this. For example, the name of the organization, address, phone number, a link to website information, directions, etc. may be made available. Classifications may be added so the user can go right to the type of shelter needed, including Section 8, short-term supportive housing, one month of rent assistance, etc. An emergency hotline may also be added.

The utilities screen 608 in FIG. 6 may contain some of the same elements as the prior one which may maintain continuity, and may keep the module in a simple format for the users for ease of navigation. Specific classifications may not always be necessary. The user may have access to utility programs, budget billing, the potential to receive one month's assistance from nongovernment organizations (NGOs), etc.

The food screen 610 of FIG. 6 may provide collaboration. Through the Family Support Division of the Department of Social Services, the user can press apply, prescreen, review or change in order to file the necessary paperwork to gain access to benefits such as food stamps. A phone number gives access to a Customer Service Representative. For those who prefer to file their papers in office, a website link may be made available for office locations and directions. Once in this website, other information is made available. The pantry classification may direct the user to a phone hotline providing location, day, time, directions, etc. to the nearest pantry in the area. A link can reveal information about diet and nutrition for this demographic. The user can be alerted when a pantry is out of food. For soup kitchens, the name of the organization, date, time, directions, etc. may be most important. What is interesting about this classification is the user and stakeholders can see when food is not available and make the necessary arrangements to fulfill this need, which may include partnering in new ways. The user can press on the shelter icon to take the user back to a listing for food and shelter if the situation becomes dire.

When returning to the My Home (MH) application, a user may enter financial assistance or adjusted expenses. The user may have been preapproved for Section 8 housing assistance. A nongovernment organization might have provided one month support on electricity and gas. The user could have qualified for the Food Stamp Program.

In summary of the example My Community (MC) application, each individual icon may link directly to resources and services as defined by that need to provide providing user applications, change forms, pre-screenings, etc., may allow a user to check status (e.g., verification), review applications (e.g., for problems, etc.), etc. The application may allow for the ability to pre-date scheduled lay-offs due to seasonality or contract work-flow, may provide financial support, live chat capability, phone numbers, websites, locations, mapping, a drop down list for selection and instructions (e.g., definitions, help, FAQ, etc.), etc. Information may be sorted based on the demographic of the user, user's past interaction with the module, etc.

FIG. 6 shows some of the ways service delivery can be improved, by linking My Home (MH) and My Community (MC) applications to stakeholders and the resources and services within them. The examples identified herein can be built upon and enhanced, while developing and implementing collaborative efforts.

The example modules have breadth of design and can expand across cities, counties and regions. The modules may provide budgeting, resources and services (that may be downloaded via GPS location), with a mechanism for feedback, and offer more than just a website directory. The modules may embody systems production and research modifications for each transitioning group.

What is documented here is just one depiction of how these modules may perform, as designed for each transitioning group. The underlying equation of Need+Resources and Services=Met Need can be used in developing other uses for these modules.

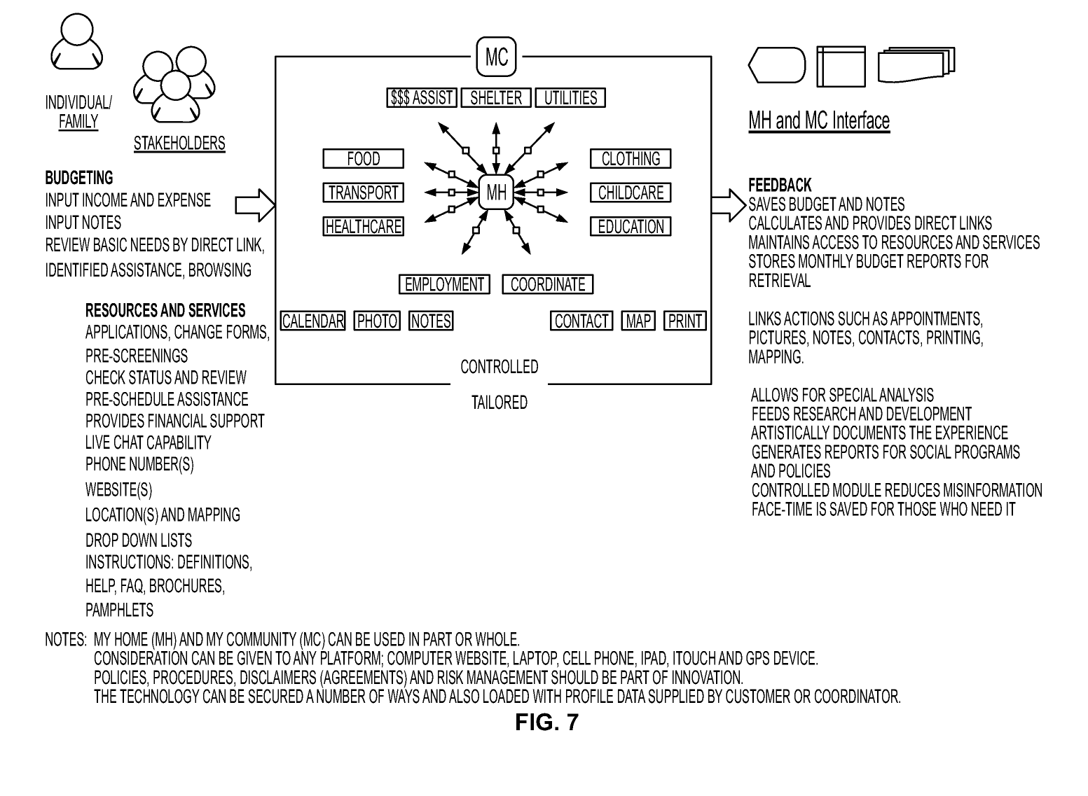

FIG. 7 is a summary diagram of the example My Home (MH) and My Community (MC) interfaces illustrating example capabilities for budgeting, accessing resources and services, and obtaining feedback.

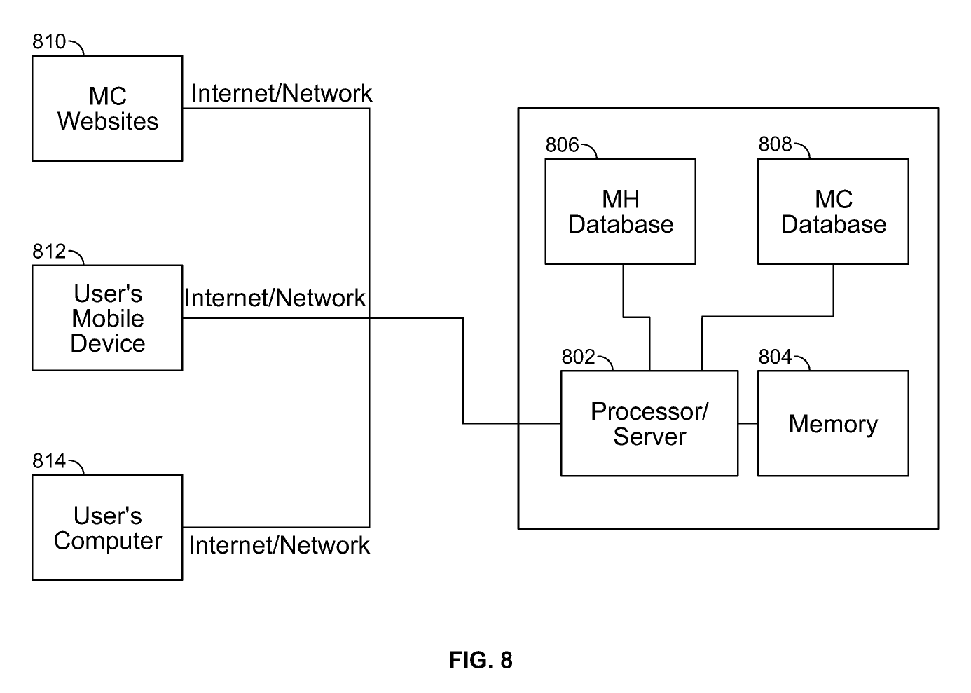

FIG. 8 is a block diagram of one example of one embodiment of a system according to the invention. A processor/server 802 executes computer executable instructions stored in memory 804 to implement the systems and methods as noted herein. Data relating to My Home (MH) is stored in MH database 806 and data relating to My Community (MC) is stored in MC database 808, both of which are accessed by the processor/server 802. The processor/server 802 is linked by the Internet or a network to MC websites 810 for accessing the MC data to be presented to the user. Some or all of the MC data can be stored in the MC database 806.

For purposes of illustration, programs and other executable program components, such as the operating system, are illustrated herein as discrete blocks. It is recognized, however, that such programs and components reside at various times in different storage components of a computing device, and are executed by a data processor(s) of the device.

Although described in connection with an exemplary computing system environment, embodiments of the aspects of the invention are operational with numerous other general purpose or special purpose computing system environments or configurations. The computing system environment is not intended to suggest any limitation as to the scope of use or functionality of any aspect of the invention. Moreover, the computing system environment should not be interpreted as having any dependency or requirement relating to any one or combination of components illustrated in the exemplary operating environment. Examples of well-known computing systems, environments, and/or configurations that may be suitable for use with aspects of the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Embodiments of the aspects of the present disclosure may be described in the general context of data and/or processor-executable instructions, such as program modules, stored on one or more tangible, non-transitory storage media and executed by one or more processors or other devices. Generally, program modules include, but are not limited to, routines, programs, objects, components, and data structures that perform particular tasks or implement particular abstract data types. Aspects of the present disclosure may also be practiced in distributed computing environments where tasks are performed by remote processing devices that are linked through a communications network. In a distributed computing environment, program modules may be located in both local and remote storage media including memory storage devices.

In operation, processors, computers and/or servers may execute the processor-executable instructions (e.g., software, firmware, and/or hardware) such as those illustrated herein to implement aspects of the invention.

Embodiments of the aspects of the present disclosure may be implemented with processor-executable instructions. The processor-executable instructions may be organized into one or more processor-executable components or modules on a tangible processor readable storage medium. Aspects of the present disclosure may be implemented with any number and organization of such components or modules. For example, aspects of the present disclosure are not limited to the specific processor-executable instructions or the specific components or modules illustrated in the figures and described herein. Other embodiments of the aspects of the present disclosure may include different processor-executable instructions or components having more or less functionality than illustrated and described herein.

According to another example embodiment, a mobile computing device for accessing basic need resources (e.g., services, agencies, programs, etc.) generally includes a processor, memory configured to store information, a display configured to display information to a user, a global positioning satellite receiver configured to receive a global positioning satellite signal to determine a location of the computing device, and a wireless communication element configured for wireless communication via one or more wireless networks.

The processor may be any suitable processor, including a central processing unit, microcontroller, microprocessor, integrated circuit, etc. The processor may be configured to execute any suitable computer-executable instructions, including machine language code, assembly language code, java code, C++ code, etc. The memory may be any suitable memory for storing information, data, etc. including one or more hard drives, flash drives, random access memory, etc.

The display may be any suitable display for displaying information to a user, including a display screen, a touchscreen, etc. The mobile computing device may also include an input device, which may include a keypad, keyboard, touchscreen, etc. The input device may be the same as the display or different.

The global positioning satellite (GPS) receiver may be any suitable GPS receiver including a GPS antenna, GPS receiving element, GPS transmitter, GPS transceiver, etc. The GPS receiver may be configured to receive satellite signals for determining location from any satellite based location service, including GPS, GLONASS, GALILEO, etc.

The wireless communication element may be any suitable element capable of communicating with a wireless network, including a wireless antenna, wireless receiver, wireless transmitter, wireless transceiver, etc. The wireless communication element may communicate with one or more of any suitable wireless networks, including cellular networks (e.g., 3G, 4G, LTE, etc.), WiFi networks, local area networks, the Internet, Bluetooth, etc.

As previously described, the mobile computing device may be any suitable mobile computing device, including a smartphone, a tablet computer, a personal digital assistant, a portable media player, an IPOD TOUCH, an IPAD, an IPHONE, etc.

The mobile computing device may be configured to determine a location of the computing device based on the GPS signal received by the GPS receiver, so that the mobile computing device can determine its location. In other embodiments, the mobile computing device may determine its location using any other suitable method, including determining a location of the wireless network the mobile computing device is connected to (e.g., based on IP address or other address of a WiFi network, based on location of a cellular tower of a cellular network, etc.), prompting a user to enter a location, etc.

The mobile computing device may then communicate with one or more wireless networks via the wireless communication element to determine one or more basic need resources located near the location of the computing device. For example, after determining the location of the mobile computing device, the mobile computing device may locate basic need resources that are near (e.g., close to, closest to, within a threshold distance of, etc.) the location of the mobile computing device. For example, the mobile computing device may connect to the Internet, a private database, a server, etc. to search for basic need resources that are near the location of the mobile computing device. The mobile computing device may locate only basic need resources that are closest to the mobile computing device, basic need resources located within a threshold distance (e.g., one mile, five miles, etc.) of the mobile computing device, etc.

The mobile computing device may then display resource information on the display for each of the basic need resources. The resource information may include a location of each basic need resource, instructions for the user on how to access each basic need resource, etc. The mobile computing device may display both the location of a basic need resource and instructions for accessing the resource. These items may be displayed simultaneously, displayed separately, etc. The display may show a location of the basic need resource first, and then instructions on how to access the basic need resource after the user selects the basic need resource.

These features may allow a user to quickly obtain information about basic need resources located close to the user. For example, a user may use the mobile computing device to automatically determine which basic need resources are closest to the user. This helps the user, who might not otherwise know where to go for basic need resource assistance, to quickly locate assistance in meeting basic needs. Displaying information about how to access the basic need resource further helps the user by assisting the user in taking steps/actions to access the basic need resource. Accordingly, this example mobile computing device may help users to easily access basic need resources by showing both the location of the nearest basic need resources and instructions on how to access the nearest basic need resources.

The mobile computing device may display basic need resources in multiple basic need categories. The basic need categories may be any suitable categories, including a shelter category, a utilities category, a food category, a clothing category, a childcare category, a healthcare category, a transportation category, an education category, and an employment category, etc. Accordingly, the mobile computing device may allow the user to search for specific basic need resources according to the user's current needs. The categories may allow the user to filter basic need resources, focus only on currently needed resources, etc.

For each basic need resource, the mobile computing device may display one or more pieces of information, links, etc. to help the user access the basic need resource. For example, the mobile computing device may display one or more links including links to an application for a basic need resource, a change form for the basic need resource, a pre-screening form for the basic need resource, updates for the basic need resource, schedules for the basic need resource, financial support for the basic need resource, live chat regarding the basic need resource, phone number(s) regarding the basic need resource, website(s) regarding the basic need resource, a location of the basic need resource, documentation regarding the basic need resource, etc. Accordingly, the user may be able to directly access links, documents, etc. to assist the user in accessing the resource directly from the mobile computing device.

The mobile computing device may be configured to automatically perform one or more actions for the user. For example, the device may automatically fill out an application for a basic need resource based on a profile of the user (e.g., as previously generated by the user or another, etc.). The user may enter information into a general profile, and the device can automatically fill out applications for the user to assist the user in accessing the basic need resource more easily, quickly, efficiently, etc. As another example, the mobile computing device may automatically contact one or more agencies, etc. nearby that provide a basic need resource to provide information about the user to the one or more nearby agencies. The user's profile information may be sent to the agency as soon as the user searches for a basic need resource, selects a basic need resource, etc. to assist the user in accessing the basic need resource more easily, quickly, efficiently, etc. The information may be sent in an email, a text message, a phone call, etc.

The mobile computing device may be configured to receive feedback about a basic need resource from users who have experienced accessing the basic need resource. The feedback can then be presented to other users. This allows for feedback, reviews, etc. to be collected so that other users can better decide which basic need resources are the most helpful, determine what the user needs to provide to the basic need resource to get assistance more quickly and easily, etc.

The mobile computing device may also be configured to store data regarding use of the basic need resources by a user and transmit the stored data to a third party to analyze for research purposes. For example, governments, universities, non-profit organizations, etc. may be able to analyze collected data to determine how the basic need resources are being used to help improve access to the basic need resources in the future.

When transmitting personal information about a user to a third party, the mobile computing device may hide some of the personal details for security purposes. The personal data may be secured using any suitable data transmission security, privacy, etc. techniques. For example, some details of the personal information may be altered or encrypted for transmission so that intercepted data will not be understood by any parties who are not intended to receive the information. The third party meant to receive the information could then decode it to get the personal information of the user.

The mobile computing device may be configured to display a budget on the display. The budget may have one or more budget categories for inputting budget expenses, income, etc. of the user. The budget categories may correspond to basic need resource categories described above.

After receiving budget information from the user, the mobile computing device may then determine whether a budget deficiency exists for each category. If a category does have a budget deficiency, the device may display a linking button adjacent (e.g., next to, below, etc.) the budget category having a deficiency. The linking button may link the user to nearby basic need resources corresponding to the budget category having the deficiency. This may allow a user to be provided with only basic need resources corresponding to the areas in which the user needs assistance. For example, if a user has sufficient income to meet shelter expenses, but a deficiency in a utilities budget category, the user will be provided with nearby utility basic need resources. This allows a user to focus on the most important needs for the user as determined by the budget, and will help the user to more easily the user's basic needs.

According to another example embodiment, a method of accessing basic need resources via a mobile computing device generally includes determining a location of the computing device based on a global positioning satellite signal received by a global positioning satellite receiver, communicating with one or more wireless networks via a wireless communication element to determine one or more basic need resources located near the location of the computing device, and displaying resource information on the display for each of the one or more basic need resources. The resource information includes, for each of the one or more basic need resources, both a location of said basic need resource and instructions for the user on how to access said basic need resource.

The method may include displaying a budget on the display having one or more budget categories, receiving budget input information from the user corresponding to each of the one or more budget categories, determining whether a budget deficit exists for each of the one or more budget categories, and displaying one or more linking buttons on the display adjacent each budget category that has a budget deficit, each linking button configured to link the user to one or more of said nearby basic need resources corresponding to said budget category having the budget deficit.

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one or more of the operations described herein, including in the claims.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A mobile computing device for accessing basic need resources, the device comprising:
a processor;
memory coupled to the processor and configured to store information;
a display coupled to the processor and configured to display information to a user;
a global positioning satellite receiver coupled to the processor and configured to receive a global positioning satellite signal to determine a location of the computing device; and
a wireless communication element coupled to the processor and configured for wireless communication via one or more wireless networks;
wherein the processor is configured to execute computer-executable instructions to cause the processor to:
determine a location of the computing device based on the global positioning satellite signal received by the global positioning satellite receiver;
communicate with one or more wireless networks via the wireless communication element to determine one or more basic need resources located near the location of the computing device; and
display resource information on the display for each of the one or more basic need resources, the resource information including, for each of said one or more basic need resources, both a location of said basic need resource and instructions for the user on how to access said basic need resource.

2. The computing device of claim 1, wherein the computing device is one of a smartphone, a tablet computer, a personal digital assistant, and a portable media player.

3. The computing device of claim 1, wherein:
the one or more basic need resources include a first basic need resource belonging to a first basic need category and a second basic need resource belonging to a second basic need category; and
the first basic need category and the second basic need category are different.

4. The computing device of claim 3, wherein the first basic need category and the second basic need category each belong to one of a shelter category, a utilities category, a food category, a clothing category, a childcare category, a healthcare category, a transportation category, an education category, and an employment category.

5. The computing device of claim 4, wherein the one or more basic need resources include multiple basic need resources with at least one basic need resource belonging to each of the shelter category, the utilities category, the food category, the clothing category, the childcare category, the healthcare category, the transportation category, the education category, and the employment category.

6. The computing device of claim 1, wherein the processor is configured to execute computer-executable instructions to cause the processor to display one or more links each corresponding to one of the one or more basic need resources, each of the one or more links including a direct link to at least one of an application for said basic need resource, a change form for said basic need resource, a pre-screening form for said basic need resource, updates for said basic need resource, schedules for said basic need resource, financial support for said basic need resource, live chat regarding said basic need resource, phone number(s) regarding said basic need resource, website(s) regarding said basic need resource, a location of said basic need resource, and documentation regarding said basic need resource.

7. The computing device of claim 1, wherein the processor is configured to execute the computer-executable instructions to cause the processor to automatically fill out an application for the basic need resource(s) based on a profile of the user.

8. The computing device of claim 1, wherein the processor is configured to execute the computer-executable instructions to cause the processor to automatically contact one or more nearby agencies providing the basic need resource(s) to provide information about the user to the one or more nearby agencies.

9. The computing device of claim 1, wherein the processor is configured to execute the computer-executable instructions to cause the processor to:
receive feedback about the basic need resource(s) based on a user experience of another user of the basic need resource; and
display the feedback to the user of the mobile computing device.

10. The computing device of claim 1, wherein the processor is configured to execute the computer-executable instructions to cause the processor to:
store data regarding use of the basic need resource(s) by the user of the mobile computing device; and
transmit the stored data to a third party to allow the third party to analyze the use of the basic need resource(s) for research purposes.

11. The computing device of claim 1, wherein the processor is configured to execute the computer-executable instructions to cause the processor to:
receive a user profile from the use including personal information about the user;
change a portion of the personal information about the user to hide the personal information from third parties; and
transmit the changed portion of the personal information to the one or more basic need resources to protect the personal information of the user of the mobile computing device.

12. The computing device of claim 1, wherein the wireless communication element is a cellular antenna configured to wirelessly transmit information to a cellular network and wirelessly receive information from a cellular network.

13. The computing device of claim 1, wherein the processor is configured to execute the computer-executable instructions to cause the processor to:
display a budget on the display having one or more budget categories;
receive budget input information from the user corresponding to each of the one or more budget categories;
determine whether a budget deficit exists for each of the one or more budget categories; and
display one or more linking buttons on the display adjacent each budget category that has a budget deficit, each linking button configured to link the user to one or more of said nearby basic need resources corresponding to said budget category having the budget deficit.

14. A mobile computing system for accessing basic need resources, the system comprising:
a processor;
memory coupled to the processor and configured to store information;
a display coupled to the processor and configured to display information to a user;
a wireless communication element coupled to the processor and configured for wireless communication via one or more wireless networks;
wherein the processor is configured to execute computer-executable instructions to cause the processor to:
display a budget on the display having one or more budget categories;
receive budget input information from the user corresponding to each of the one or more budget categories;
determine whether a budget deficit exists for each of the one or more budget categories; and
for each budget category having a budget deficit, determine one or more basic need resources corresponding to the budget category and located near the location of the computing system, and display a linking button adjacent said budget category having the budget deficit, the linking button configured to link the user to said one or more basic need resources corresponding to said budget category having the budget deficit.

15. The mobile computing system of claim 14, wherein the computing device is one of a smartphone, a tablet computer, a personal digital assistant, and a portable media player.

16. The mobile computing system of claim 14, wherein the budget categories include at least one of a shelter category, a utilities category, a food category, a clothing category, a childcare category, a healthcare category, a transportation category, an education category, and an employment category.

17. The mobile computing system of claim 14, wherein the processor is configured to execute the computer-executable instructions to cause the processor to, when a user selects a linking button adjacent a budget category having a budget deficit, display both a location of said basic need resource and instructions for the user on how to access said basic need resource.

18. The mobile computing system of claim 1, further comprising a global positioning satellite receiver configured to receive a global positioning satellite signal to determine a location of the mobile computing system, wherein the processor is configured to execute the computer-executable instructions to cause the processor to determine a location of the mobile computing system based on the received global positioning satellite signal.

19. A computer-implemented method of accessing basic need resources via a mobile computing device, the mobile computing device comprising a processor, memory, a display, a global positioning satellite receiver, and a wireless communication element, the method comprising:
determining a location of the computing device based on a global positioning satellite signal received by the global positioning satellite receiver;
communicating with one or more wireless networks via the wireless communication element to determine one or more basic need resources located near the location of the computing device; and
displaying resource information on the display for each of the one or more basic need resources, the resource information including, for each of said one or more basic need resources, both a location of said basic need resource and instructions for the user on how to access said basic need resource.

20. The method of claim 19, further comprising:
displaying a budget on the display having one or more budget categories;
receiving budget input information from the user corresponding to each of the one or more budget categories;
determining whether a budget deficit exists for each of the one or more budget categories; and
displaying one or more linking buttons on the display adjacent each budget category that has a budget deficit, each linking button configured to link the user to one or more of said nearby basic need resources corresponding to said budget category having the budget deficit.
